(19) United States
(12) Patent Application Publication
(10) Pub. No.: US 2014/0358930 A1
(43) Pub. Date: Dec. 4, 2014

(54) CLASSIFYING MESSAGE CONTENT BASED ON REBROADCAST DIVERSITY

(71) Applicants: Kristina Lerner, Los Angeles, CA (US); Rumi Ghosh, Palo Alto, CA (US)

(72) Inventors: Kristina Lerman, Los Angeles, CA (US); Rumi Ghosh, Palo Alto, CA (US)

(73) Assignee: UNIVERSITY OF SOUTHERN CALIFORNIA, Los Angeles, CA (US)

(21) Appl. No.: 13/904,973

(22) Filed: May 29, 2013

(51) Int. Cl. G06F 17/30

(52) U.S. Cl. CPC G06F 17/30598
USPC 707/740

(57) ABSTRACT

A computer system running a program of instructions may classify content of a message. The message may be re-broadcasted in whole or in part by one or more re-broadcasters. An amount of time interval diversity may be determined in the time intervals between each successive pair of re-broadcasted messages. An amount of re-broadcaster diversity may be determined in the number of times the message has been re-broadcasted by each of the re-broadcasters. The content of the message may be classified based on the amount of time interval diversity and the amount of re-broadcaster diversity.

### CROSS-REFERENCE TO RELATED APPLICATION

This application is based upon and claims priority to U.S. provisional patent application 61/652,982, entitled “INFORMATION-THEORETIC METHOD TO IDENTIFY SPAM IN SOCIAL MEDIA,” filed May 30, 2012, attorney docket number 028080-0750. The entire content of this application is incorporated herein by reference.

### STATEMENT REGARDING FEDERALLY SPONSORED RESEARCH

This invention was made with government support under Grant No. FA9550-10-1-0102, 1295 G NA276, awarded by Air Force Office of Scientific Research, and under Grant No. IIS-0968370, awarded by the National Science Foundation. The government has certain rights in the invention.

### BACKGROUND

1. Technical Field

This disclosure relates to classifying message content, including classifying social media content, such as tweets on Twitter™, as span and other types of content.

2. Description of Related Art

Twitter is used for a variety of reasons, including information dissemination, marketing, political organizing and to spread propaganda, spamming, promotion, conversations, and so on. Characterizing these activities and categorizing associated user generated content can be a challenging task.

Twitter has emerged as a critical factor in information dissemination, marketing, S. Wu, J. M. Hofman, W. A. Mason, and D. J. Watts, “Who Says What to Whom on Twitter”, In Proceedings of World Wide Web Conference (WWW '11), 2011, and influence discovery. It has also become an important tool for mobilizing people, as witnessed by the events of the 2011 ‘Arab spring’ “The face of egypt's social networking revolution”, In http://www.cbsnews.com/stories/2011/02/12/eveningnews/main20031662.shtml, 2011; P. Beaumont, “Can social networking overthrow a government?”, In http://www.smh.com.au/technology/technology-news/can-social-networking-overthrow-a-government-20110225-1b7u6.html, 2011, and for crisis management, when it was used to reconnect Japanese earthquake victims with loved ones and to provide real time information during the subsequent nuclear disaster (S. Kessler, “Social media plays vital role in reconnecting japan quake victims with loved ones”, In http://mashable.com/2011/03/14/internet-intact-japan/, 2011). In the cultural arena, Twitter has developed into an effective mouthpiece for celebrities, “Social networking sites used by celebrities—the twitter Revolution”, In http://www.twittingsound.com/social-networking-sites-used-by-celebrities-the-twitter-revolution.html, 2011, spawning a generation of stars, like Justin Bieber, and starlets (“Lady gaga a bigger twitter star than justin bieber—10 million fans say so”, In http://sanfrancisco.ibtimes.com/articles/147005/20110517/1ady-gaga-a-bigger-twitter-star-justin-beiber-10-million-fans-say.htm, 2011). As a consequence, new social marketing strategies and sophisticated automated promotion campaigns have risen. Information dissemination, advertising, propaganda campaigns, bot retweeting and spamming are some of the many diverse activities occurring on Twitter.

Examples of retweeting activity illustrate the richness of Twitter dynamics. Differentiating between these diverse activities on Twitter and classifying the short posts can be a challenging problem. For example, a post that is retweeted multiple times by the same user may be categorized as spam. However, if the same message is of interest to and retweeted by many other users, it can be classified as a successful campaign or information dissemination. Such judgments may be difficult to make based solely on content. The advent of bots and automatic tweeting services have added another dimension of complexity to the already difficult problem. How distinguish human activity from programmed or bot activity, as well as campaigns designed to manipulate opinion from those that capture users' interest, and popular from unpopular content?

It thus can be challenging to quickly and economically classify content in a message, such as content in social media, such as the content of a tweet on Twitter™.

R. Crane and D. Sornette, “Viral, quality, and junk videos on youtube: Separating content from noise in an information-rich environment”, In Proceedings of the AAAI Symposium on Social Information Processing, 2008, describe a method based on dynamics of collective user activity on YouTube to automatically distinguish quality videos from junk videos. However, this method may only discover three classes of activity and videos, while heterogeneous activity in social media may require more than three classes.

Some existing spam detection, B. Markines, C. Cattuto, and F. Menczer, “Social spam detection”, In Proceedings of the 5th International Workshop on Adversarial Information Retrieval on the Web, Al RWeb '09, pages 41-48, New York, N.Y., USA, 2009. ACM; Y. Xie, F. Yu, K. Achan, R. Panigrahy, G. Hulten, and I. Osipkov, “Spamming botnets: signatures and characteristics”, SIGCOMM Comput. Commun. Rev., 38(4):171-182, August 2008, and trust management systems J. Caverlee, L. Liu, and S. Webb. Socialtrust: “tamper-resilient trust establishment in online communities”, In JCDL '08: Proceedings of the 8th ACM/IEEE-CS joint conference on Digital libraries, pages 104-114, New York, N.Y., USA, 2008, ACM, look at content and structure. They may require additional constraints, like labeled up-to-date annotation of resources and access to content and cooperation of search engine. These may be difficult to satisfy due to the diversity and quantity of messages in social media.

C. Grier, K. Thomas, V. Paxson, and M. Zhang, “@spam: the underground on 140 characters or less”, In Proceedings of the 17th ACM conference on Computer and communications security, CCS '10, pages 27-37, New York, N.Y., USA, 2010, ACM, analyzed the features of spam on Twitter. They detect spam using three blacklisting services. Similarly, another method employed to remove spam on Twitter uses Clean Tweets, H. Kwak, C. Lee, H. Park, and S. Moon, “What is Twitter, a social network or a news media?”, In Proceedings of the 19th international conference on World wide web, WWW '10, pages 591-600, New York, N.Y., USA, 2010, ACM. Clean tweets filter tweets from users who are less than a day (or any duration specified) old and tweets that mention three (or any number specified) trending topics. However, this approach may be unable to detect spammers who auto-tweet or post spam-like tweets at regular intervals (like EasyCash435 or on strategy, FIGS. 1(g) and (h)). Also, URL shortening services such as http://bit.ly are used on Twitter. Users may not be able to guess which references are pointed at, which in turn may be an attractive feature for spammers. S. Yardi, D. Romero, G. Schoenebeck, and D. Boyd. “Detecting spam in a Twitter network”, First Monday, 15(1), January 2010 state “Twitter spam varies in style and tone; some approaches are well-worn and transparent and others are deceptively sophisticated and adaptable.”

Previous work provided a binary (such as low-quality vs. high quality content) or tertiary classification of content based on analysis of content and structure. See E. Agichtein, C. Castillo, D. Donato, A. Gionis, and G. Mishne, “Finding high-quality content in social media”, In Proceedings of the international conference on Web search and web data mining, WSDM '08, pages 183, 194, New York, N.Y., USA, 2008, ACM, or user response to it, R. Crane and D. Sornette, “Viral, quality, and junk videos on youtube: Separating content from noise in an information-rich environment”, In Proceedings of the AAAI Symposium on Social Information Processing, 2008. However, the rich, heterogenous and complex activity on Twitter may necessitate the need for a more detailed characterization.

Quickly and inexpensively classifying message content, including classifying social media content such as tweets on Twitter™, as span and other types of content, remains challenging.

### SUMMARY

A computer system running a program of instructions may classify the content of a message that is re-broadcasted in whole or in part by one or more re-broadcasters. An amount of time interval diversity may be determined in the time intervals between each successive pair of re-broadcasted messages. An amount of re-broadcaster diversity may be determined in the number of times the message has been re-broadcasted by each of the re-broadcasters. The content of the message may be classified based on the amount of time interval diversity and the amount of re-broadcaster diversity.

The message may be a tweet on Twitter™. Each rebroadcast may be a retweet on Twitter™.

The message may include a URL. Each rebroadcast may include the URL.

The amount of time interval diversity and/or the amount of re-broadcaster diversity may be computed using entropy or a different method.

The classifying may equate a low amount of time interval diversity with automatic or robotic activity; a high amount of re-broadcaster diversity and a high amount of time interval diversity with newsworthy information; a low amount of time interval diversity and a low amount of re-broadcaster diversity with spam; a low amount of re-broadcaster diversity with an advertisement or promotion; and/or a low amount of re-broadcaster diversity and a high amount of time interval diversity with a campaign.

The classifying may be performed without analyzing the content. For example, the message may contain text, an image, and/or a video, and the classifying may classify the text, image, and/or video without analyzing the text, image, and/or video.

The classifying may distinguish between newsworthy content and spam based on the amount of time interval diversity and the amount of re-broadcaster diversity.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIGS. 1A-1I illustrate an example of evolutions of retweeting activity for tweets containing various types of content.

FIGS. 2A-2I illustrate distributions of inter-arrival gaps for the retweeting activities shown in FIGS. 1A-1I, respectively.

FIGS. 3A-3I illustrate the number of retweets by distinct users of the retweeting activities shown in FIGS. 1A-1I, respectively.

FIG. 4 illustrates an example of manually annotated URLs shown in an entropy plane.

FIGS. 5A and 5B illustrate an example of unsupervised clustering of data points using an expectation maximizing (EM) algorithm.

FIG. 6 illustrates an example of computer-readable storage media.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

### Overview

An information-theoretic approach to classification of user activity on Twitter is presented with a focus on tweets that contain embedded URLs. Their collective ‘retweeting’ dynamics are studied.

Two features, time-interval and user entropy, may be identified and used to classify retweeting activity. Good separation of different activities may be achieved using just these two features, and content may be categorized based on the collective user response it generates.

Five distinct categories of retweeting activity on Twitter have been identified: automatic/robotic activity, newsworthy information dissemination, advertising and promotion, campaigns, and parasitic advertisement.

The techniques may be applied to other types of messaging systems, such as other types of social media systems, as well as to content other than URLs, such as text, image, and video content. The techniques may also be applied to classify other classes of information. The classification approach may not require any analysis of the content.

### Introduction

A quantitative approach is presented to classify tweet content.

An information-theoretic method may characterize the dynamics of retweeting activity generated by some content on Twitter. The method may be content and language independent. The method may nevertheless categorize content into multiple classes based on how Twitter users react to it. It may be able to separate newsworthy stories from those that are not interesting, campaigns that are driven by humans from those driven by bots, successful marketing campaigns from unsuccessful ones.

When a user posts or ‘tweets’ a story, he exposes it to other Twitter users. Tweets that contain URLs will now be discussed as an example. These URLs may be used as markers to trace the spread of information or content through the Twitter population. When a later tweet includes the same URL as an earlier one, the new post may be considered to be a ‘retweet’ of the content of the original tweet. The retweet may not be required to contain an ‘RT’ string, nor check that the user follows the author of the original tweet. Thus, retweets may include traditional retweets from the original author's followers, as well as conversations about the content associated with that URL and independent mentions of it. The collective user response to the tweet may be called the retweeting activity and may vary with the nature of content and users' interest in it.

This may in turn lead to characteristic dynamic patterns. For example, a popular news story may be retweeted by many different users (but only once by each user), whereas campaigns may get many retweets, but mainly from the same small group of users.

Some retweets, however, could be automatically generated. Relying purely on frequency of retweets may thus be misleading as to the popularity of content. The temporal signature of automated retweeting may be drastically different from human response, allowing differentiation between them.

Given some content (URL), retweeting dynamics may be characterized by two distributions: distribution of the time intervals between successive retweets and distribution of distinct users involved in retweeting. Entropy may be used to quantitatively characterize these distributions. These two numeric features may capture much of the complexity of user activity.

Using these features to classify activity on Twitter, several different types of activity may be identified, including marketing campaigns, information dissemination, auto-tweeting, and spam. In fact, some of the profiles that have been correctly identified as engaging in spam-like activities have been eventually suspended by Twitter. The approach can separate newsworthy content from promotional campaigns, independent of the language of the content, and can provide an objective measure of the value of content to people.

### Dynamics of Retweeting Activity

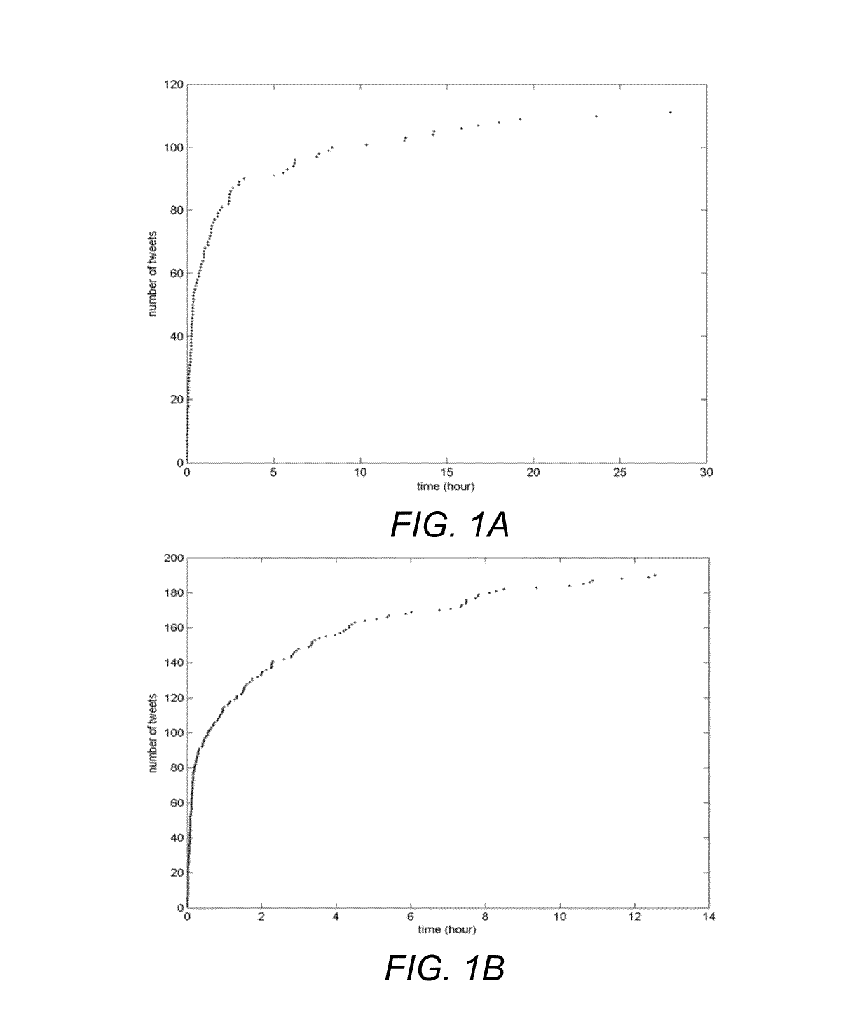

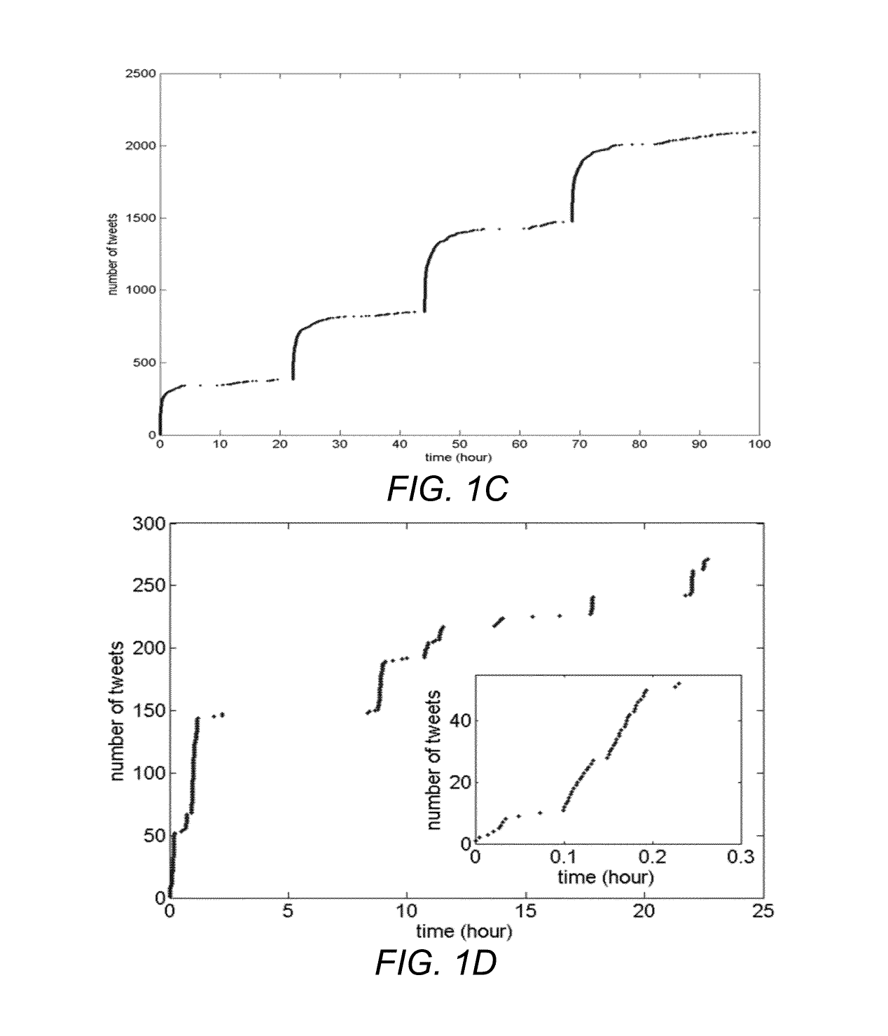

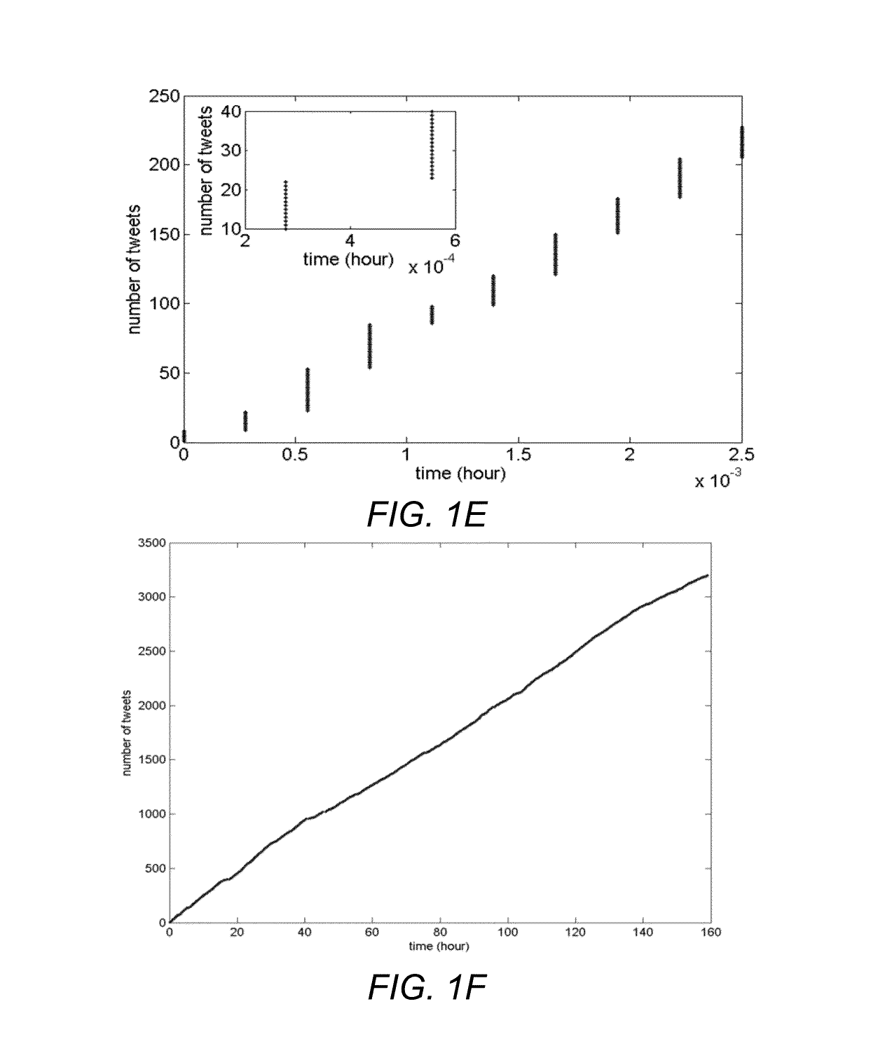

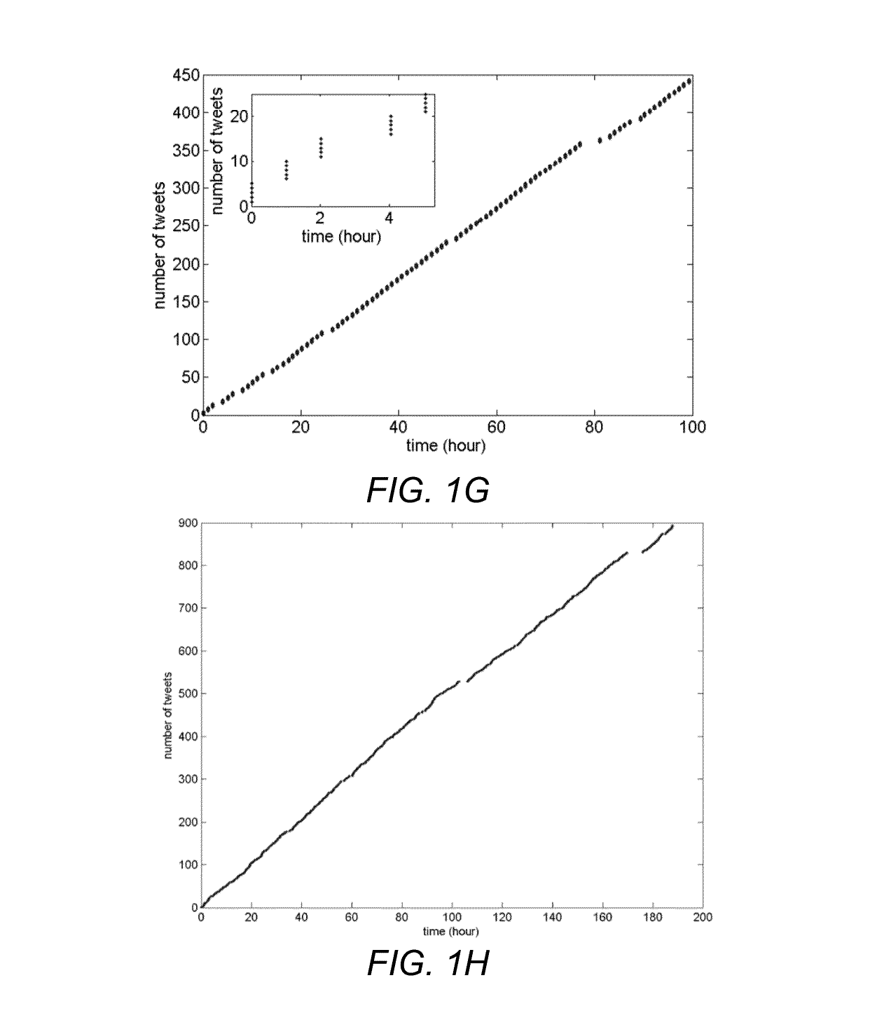

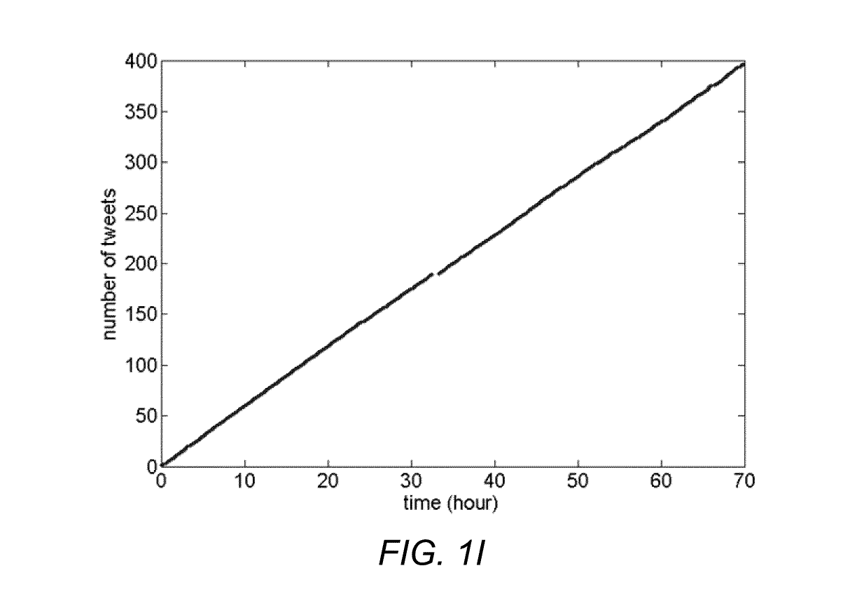

FIGS. 1A-11 illustrate an example of evolutions of retweeting activity for tweets containing various types of content. FIG. 1A illustrates an example retweeting activity for tweets containing a story posted by a popular news website (nytimes). FIG. 1B illustrates an example retweeting activity for tweets containing a story posted by a popular celebrity (billgates). FIG. 1C illustrates an example retweeting activity for tweets containing a story posted by a politician (silva_marina). FIG. 1D illustrates an example retweeting activity for tweets containing a story posted by an aspiring artist (youngdizzy). FIG. 1E illustrates an example retweeting activity for tweets containing a story posted at a fan site (AnnieBieber). FIG. 1F illustrates an example retweeting activity for tweets containing a story posted by an animal rights campaign (nokillanimalist). FIG. 1G illustrates an example retweeting activity for tweets containing an advertisement using social media (onstrategy). FIG. 1H illustrates an example retweeting activity for tweets containing an advertisement by an account that was eventually suspended by Twitter (EasyCash435). FIG. 1I illustrates an example retweeting activity for tweets containing an advertisement posted by a Japanese user (nitokono). Insets in FIGS. 1D, 1E, and 1G show automatic retweeting, with multiple retweets made within a short time period either by the same or different users.

User's response to content posted on Twitter is encoded in the dynamics of retweeting of this content. FIGS. 1A-1E shows the cumulative number of times nine different URLs were retweeted vs time. The figures show a wide variety of collective response to content. FIG. 1A shows a characteristic response to newsworthy information: fast initial rise followed by a slow saturation in the number of retweets. Such a response is typical of diffusion patterns of newsworthy information in online social networks, K. Lerman, “Social information processing in social news Aggregation”, IEEE Internet Computing: special issue on Social Search, 11(6):16{28, 2007; K. Lerman and R. Ghosh, “Information contagion: an empirical study of the spread of news on digg and twitter social networks”, In Proceedings of 4th International Conference on Weblogs and Social Media(ICWSM), 2010; F. Wu and B. A. Huberman, “Novelty and collective Attention”, In In PNAS, volume 104(45)1 7599{17601, 2007. A similar trend is also observed in the response to content (often photos) posted by major celebrities, as FIG. 1B.

Retweeting activity of posts made by starlets (without major following) may be starkly different from that of stars. FIG. 1D shows retweeting activity of a post by Young Dizzy, an aspiring artist and songwriter. Short bursts of intense activity are followed by long periods of inactivity. As later shown, this is one of the characteristics of automated tweeting, an increasingly popular feature on social media. In many of these cases, such automated retweets are generated by one or a small groups of users, pointing to attempts to manipulate the apparent popularity of content. Such automated methods to boost popularity are used not only by aspiring starlets, but also by dedicated fans of major stars, e.g., Justin Bieber as shown in FIG. 1E. In this case, fans are asked to register their Twitter accounts on a fan web site, which then automatically tweets posts about the star from their accounts. There are other example where users (or a small group of users) retweet the same message multiple times, often with the aid of some automated service, leading to a spam-like campaign. This is shown figures FIG. 1G and FIG. 1H. One of these accounts EasyCash435 was eventually suspended by Twitter. FIG. 1I shows similar characteristics of some content in Japanese. Note, that using only the retweet dynamics, without any knowledge of the content, the spam-like advertisement campaign that this profile engages in can be deduced. This is confirmed by analyzing content.

In addition to information dissemination, automated tweeting, promotional activities and advertisements, campaigns add to the diversity of Twitter dynamics. One of the successful campaigners in a sample was a Brazilian politician Marina Silva. FIG. 1C traces the retweeting activity of a post made by her over a period of 4 days. Every day she posts the same link using the social media dashboard Hootsuite (www.hootsuite.com). The retweeting activity follows a news-like trace seen in FIGS. 1A and 1B. However, when the activity gradually slows down, she breathes new life into the campaign by retweeting the same URL, generating a new upsurge in interest (and retweeting). Contrast this with an not-so-popular animal rights campaign shown in FIG. 1F, where the same few users (as shown later) are repeatedly manually retweeting some content to raise its visibility.

### Entropy-Based Analysis

Manual analysis of retweeting activity on Twitter is labor-intensive. Instead, in this section a principled approach to categorize retweeting activity associated with some content is described.

Problem Statement. Given some user-generated content or tweet cjεC (where C is a set of tweets or content), the aim is to analyze the trace, TjεT (where T is the collective activity on all content), of retweeting activity on it, to understand the content and associated dynamics. This trace, Tj can be represented by a sequence of tuples ((uⱼ₁, tⱼ₁), (uⱼ₂, tⱼ₂), . . . , (uⱼᵢ, tⱼᵢ), . . . , (u_{jK}, t_{jK})), where uⱼᵢ represents a user retweeting cⱼ at time tⱼᵢ. Given N such traces T₁, . . . , T_{N}εT and their corresponding tweets c₁, . . . , cⱼ, . . . , c_{N}εC, how do we meaningfully characterize and categorize them?

### Time Interval Distribution

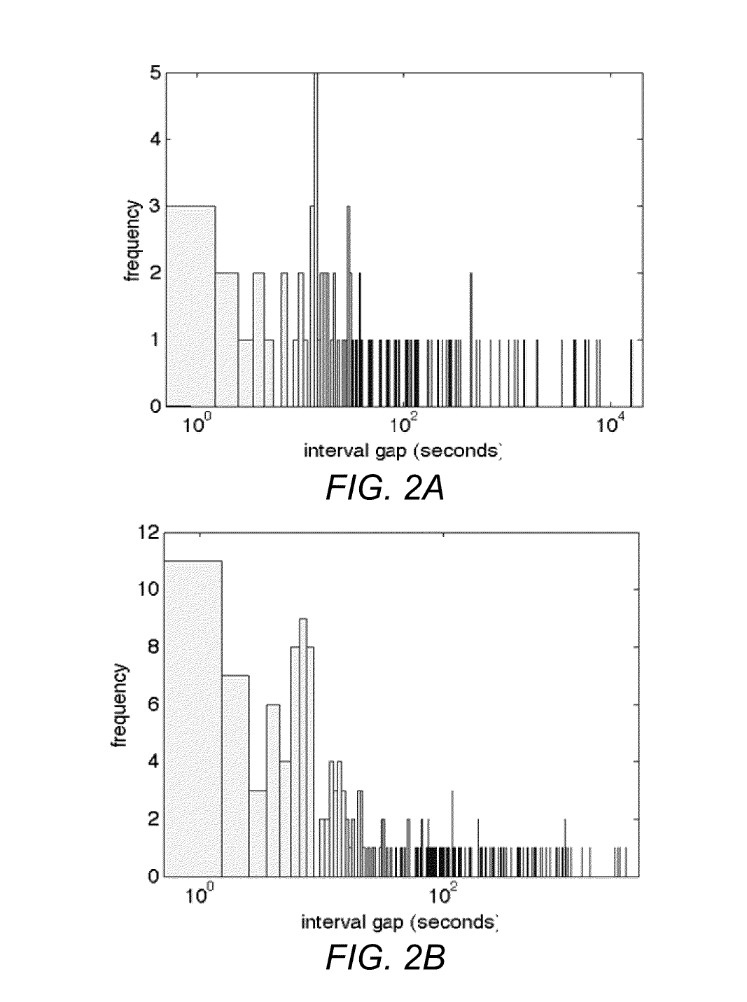

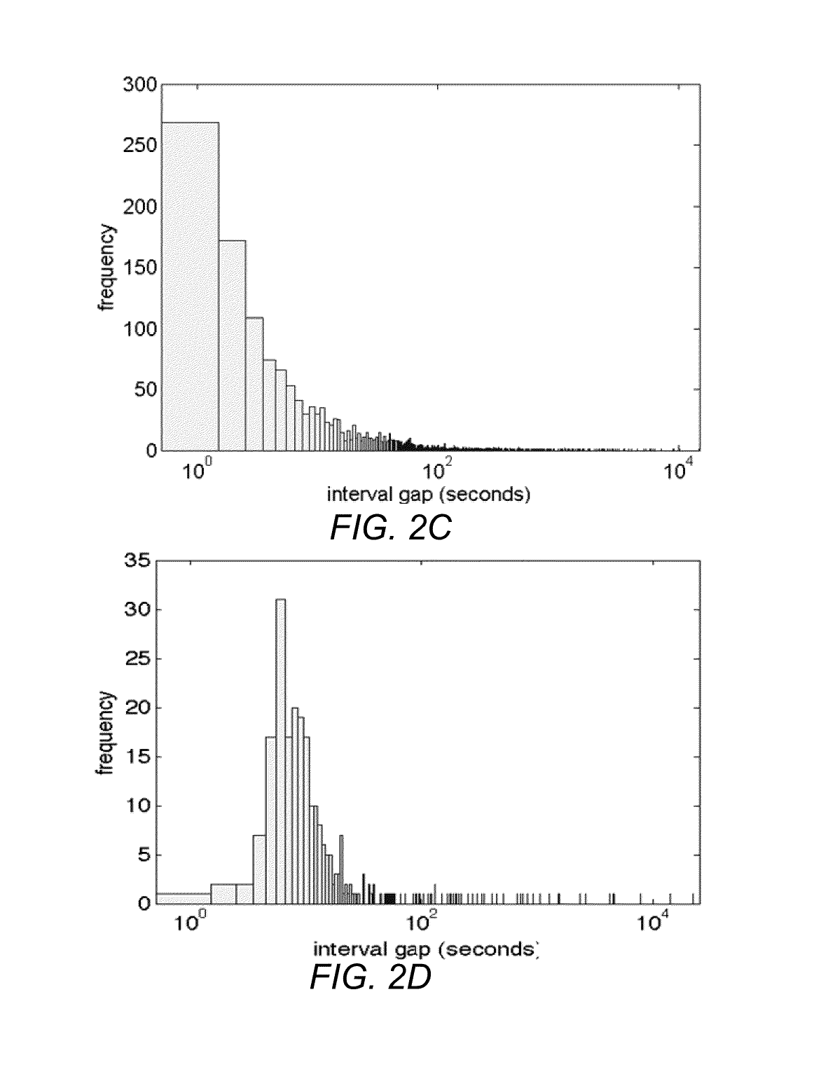

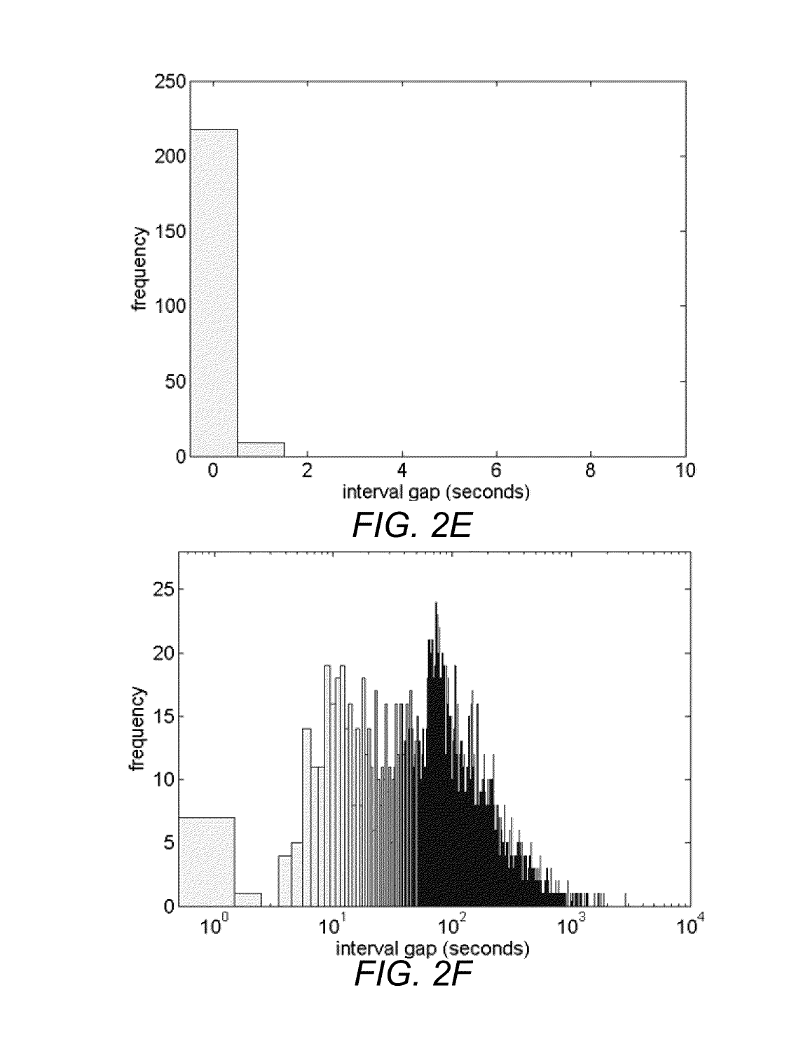

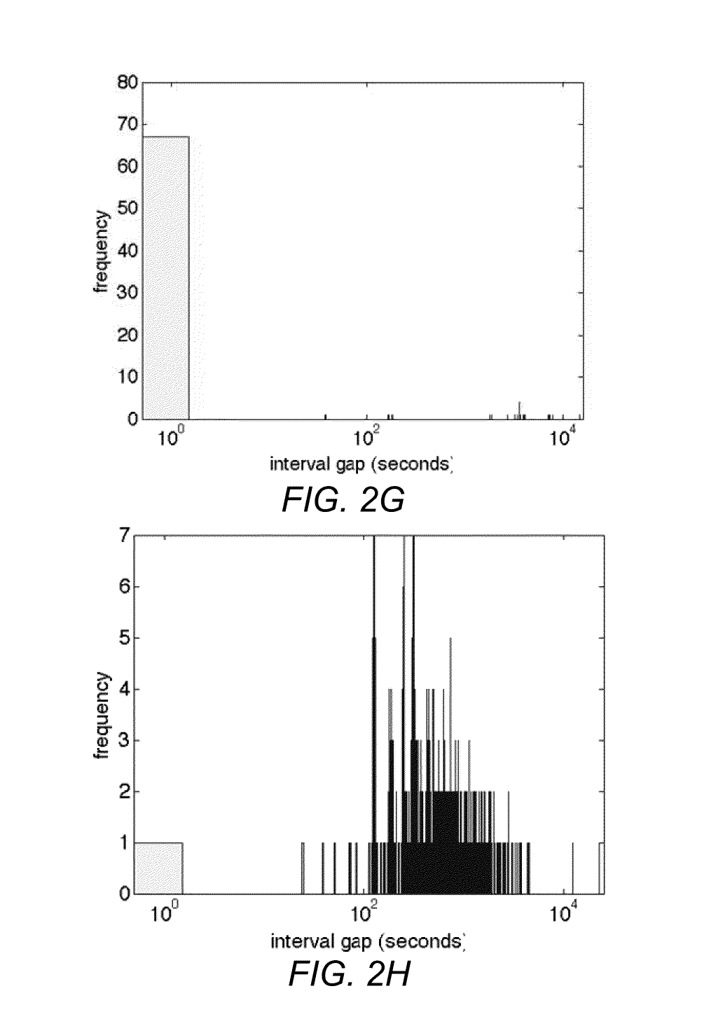

FIGS. 2A-2I illustrate distributions of inter-arrival gaps for the retweeting activities shown in FIGS. 1A-1I, respectively.

The observations made above about dynamics of retweeting can be succinctly captured by two distributions: inter-tweet time interval distribution and user distribution.

First, the distribution of time intervals between successive retweets is considered. These are shown in FIG. 2 for the same URLs whose retweeting activity is shown in FIG. 1. Humans are very heterogeneous; therefore, a signature of human activity may be a broad distribution with time intervals of many different length that may all be equally likely, as shown in FIG. 2A-FIG. 2C and FIG. 2F. Specifically, there may be a lot of activity initially associated with newsworthy content, which gradually decreases with time, resulting in many short intervals and some long ones, as shown in FIG. 2A-FIG. 2B. Automated retweeting may result in tweets at regular time intervals, which may lead to an isolated peak or peaks in the distribution (as in FIG. 2I), or bursty behavior with many zero second intervals (as seen in FIG. 2E and FIG. 2G).

The regularity or predictability of the temporal trace of tweets using time-interval entropy may be measured. Let ΔT represent the time interval between two consecutive retweets in a trace Tj with possible values {Δt₁, Δt₂, . . . , Δtᵢ, . . . , Δt_{nT}}. If there are n_{ΔT}_{ᵢ} time intervals of length Δtᵢ, then p_{ΔT} (Δtᵢ) denotes the probability of observing a time interval Δtᵢ:

$${p}_{Δ T} ( Δ {t}_{i} ) = \frac{{n}_{Δ {t}_{i}}}{{\sum }_{k = 1}^{{n}_{T}} {n}_{Δ {t}_{k}}} \qquad ( 1 )$$

The entropy H_{ΔT} of the distribution of time intervals may be:

$${H}_{Δ T} ( {T}_{j} ) = - {\sum }_{i = 1}^{{n}_{T}} {p}_{Δ T} ( Δ {t}_{i} ) log ( {p}_{Δ T} ( Δ {t}_{i} ) ) \qquad ( 2 )$$

Automatic retweeting with a regular pattern may have a lower time interval entropy, and may therefore, be more predictable than human retweeting, which may more broadly be distributed and less predictable.

### User Distribution

In addition to time interval, the distribution of the number of times distinct users retweet the content or a portion of it, such as a URL, may be measured.

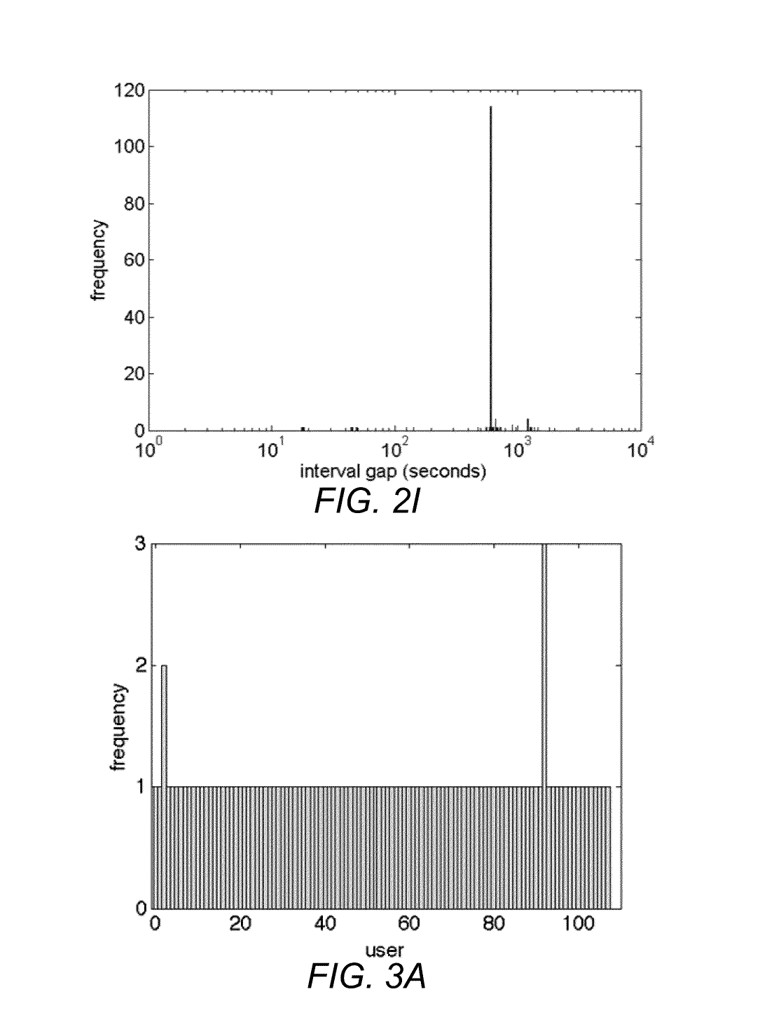

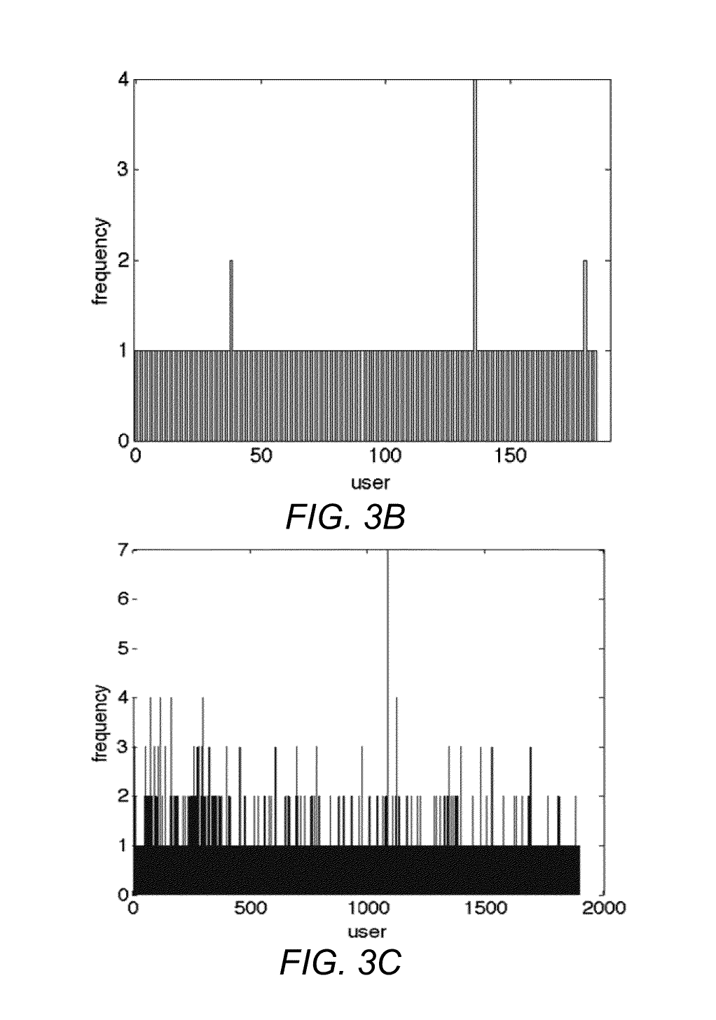

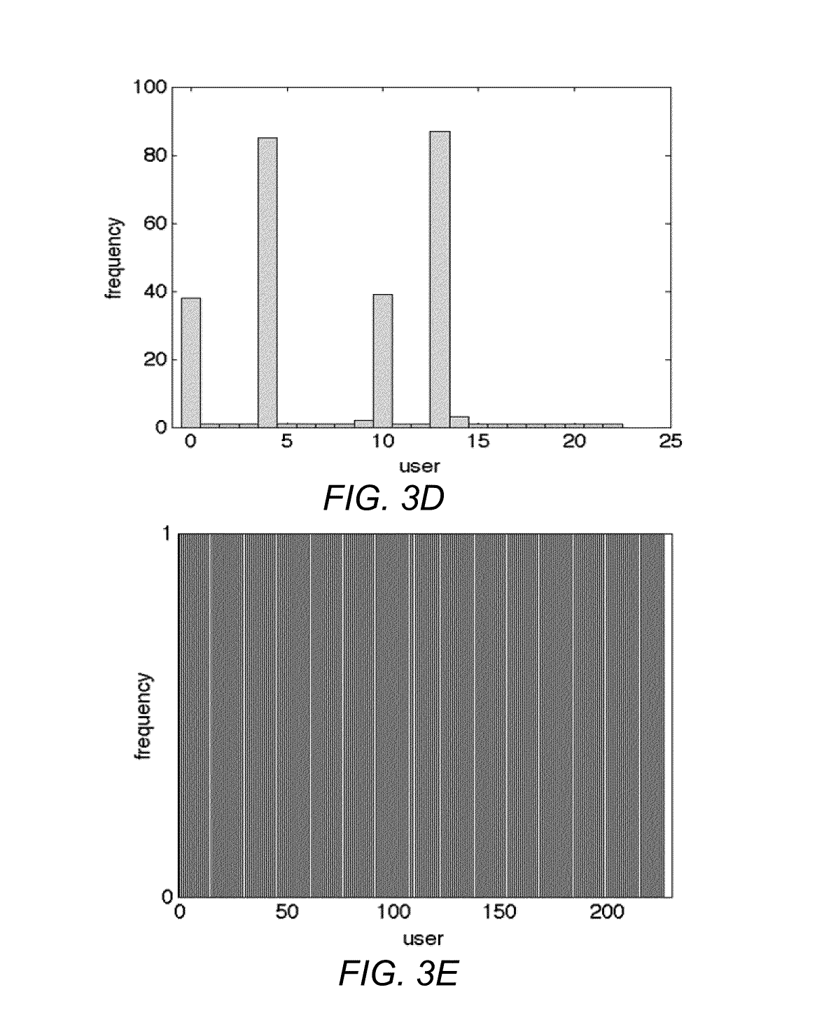

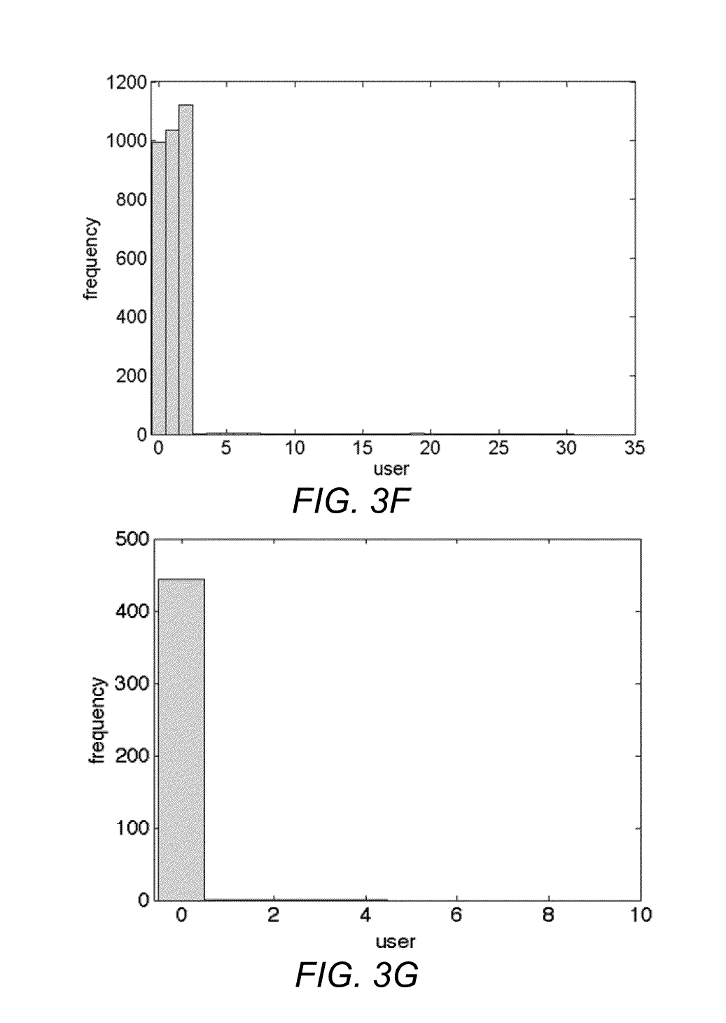

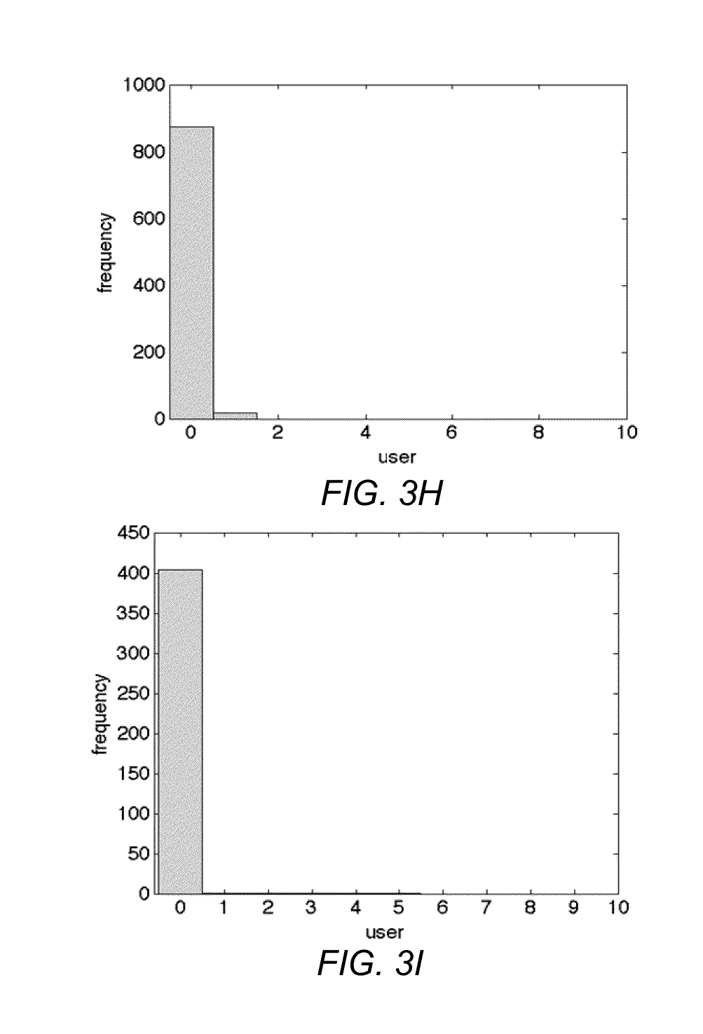

FIGS. 3A-3I show the number of retweets made by each user involved in the tweeting activity shown in FIGS. 1A-1C, respectively. Newsworthy content may usually be retweeted once by each user who participates in the tweeting activity, as shown in FIG. 3A-FIG. 3C. Spam-like activity and campaigns, on the other hand, may result when an individual (FIG. 3G-FIG. 3I) or a small group (FIG. 3F) repeatedly retweet the same post. The higher the retweeting, the greater the manipulation effort.

The campaign shown in FIG. 1C may be successful, since there are many distinct users who participate in it, as shown in FIG. 3C. However, there are some dedicated campaigners, including silva_marina herself, who retweet the same message multiple times. Also the distribution of inter-arrival times in FIG. 2C is similar to that of FIG. 2A and FIG. 2B, indicating human activity. A campaign probably not as successful as that by silva_marina is one by nokillanimalist (FIG. 1F), which has very few participating users in it. The distribution of the inter-arrival times in FIG. 2F is also comparable to FIG. 2A-FIG. 2C, with a large number of nonzero inter-arrival times and the frequency of shorter inter-arrival gaps being larger than that longer ones indicating human activity. However, the distribution of the number of retweets by distinct users shows a stark contrast. In fact it shows that there are only three dedicated users generating over 3000 retweets.

Similarly in case of the retweeting activity shown in FIG. 1H, there are only two users engaged in spreading spam-like advertisements (FIG. 3H). These two users together account for around 900 retweets. Spam-like characteristics are also observed in the advertisements, whose retweeting activity is shown in FIG. 10 and FIG. 1I which have one (FIG. 3G) and two users (FIG. 3I) generating a bulk of the content. However, on looking into the temporal distribution more closely, in case of FIG. 1G, almost two-thirds of the retweets occur almost consecutively (time interval gap is zero seconds), indicating a possible autotweeting activity. FIG. 1I also shows some kind of probable scheduled or automated tweeting activity with around 37% of the tweets having an exact interval gap of 481 seconds. Possible autotweeting is also indicated in the promotional activity shown in FIG. 1E. Although a large number of users participate in this activity as shown by FIG. 3E, almost all the retweets are generated simultaneously as seen in FIG. 2E.

Entropy may be used to measure the breadth of user distribution. Let random variable F represent a distinct user in a trace Tⱼ, with possible values {f₁, f₂, . . . , fᵢ, . . . , f_{nF}}. Let there be n_{f}_{ᵢ} retweets from user fᵢ in the trace Tⱼ. If p_{F} denotes the probability mass function of F, such that p_{F}(fᵢ) gives the probability of a retweet being generated by user fᵢ, then

$${P}_{F} ( {f}_{i} ) = \frac{{n}_{{f}_{i}}}{{\sum }_{k = 1}^{{n}_{F}} {n}_{{f}_{k}}} \qquad ( 3 )$$

The user entropy H_{F} may be given by:

$${H}_{F} ( {T}_{j} ) = - {\sum }_{i = 1}^{{n}_{F}} {p}_{F} ( {f}_{i} ) log ( {p}_{F} ( {f}_{i} ) ) \qquad ( 4 )$$

As clear from the Equation 4, in spam-like activity a small number of users are responsible for large number of tweets, which may lead to a lower entropy than retweeting activity of newsworthy content. On the other hand, automated retweeting coming from many distinct users (as in FIG. 3E) indicates that users' accounts may have been compromised.

### Classification

Time interval and user entropies H_{ΔT}(Tⱼ) and H_{F}(Tⱼ) can used to categorize the content of retweeting activity. This classification may help not only identify the different dynamic activities occurring on Twitter, but may also provide valuable insight into the nature of the associated content.

The linear runtime complexity of entropy calculation and the presence of scalable methods of clustering, P. S. Bradley, C. A. Reina, and U. M. Fayyad, “Clustering Very Large Databases Using EM Mixture Models”, Pattern Recognition, International Conference on, 2:2076+, 2000, may ensure that this entropy-based approach can be easily applied to very large data sets.

### Validation

Twitter's Gardenhose streaming API provides access to a portion of real time user activity, roughly 20%-30\% of all user activity. This API was used to collect tweets for a period of three weeks in the fall of 2010. The focus was specifically on tweets that included a URL (usually shortened by a service such as bit.ly) in the body of the message. In order to ensure that the complete retweeting history of each URL was obtained, Twitter's search API was used to retrieve all activity for that URL.

The data collection process resulted in 3,424,033 tweets which mentioned 70,343 distinct shortened URLs. There were 815,614 users in the data sample. The retweeting activity was studied of URLs posted by users who posted at least two popular URLs. By popular, this means URLs that were retweeted at least 100 times. There were 687 such distinct URLs.

The entropy based approach was applied to study the retweeting dynamics of these URLs. It shows that entropy-based analysis gives a good characterization of different types of activities observed in collective retweeting of these URLs.

### Manual Annotation

The content of each URL was manually examined (using Google translate on foreign language pages) to annotate the activity along following categories:

### News

If the URL belongs to the twitter profile of a news organization, the retweeting activity was classified as following news.

### Blogs

If the URL links to the blog or webpage maintained by an individual, the retweeting activity was classified as following blogs or celebrity.

### Campaigns

If the URL belongs to an individual or an organization with a discernible agenda (politics, animal rights issues), the retweeting activity was classified as a campaign.

### Advertisements and Promotions

If the URL links to an advertisement or promotion, the retweeting activity was classified as such. This includes instances where users post the same link repeatedly, leading to spam-like content generation, and the promotional activities of aspiring starlets.

### Parasitic Ads

This is a form of parasitic advertisement in which users participate unwittingly. This happens when a user logs into a website or web service, and then that service tweets a message in user's name telling his followers about it. For example, when a user visits sites such as Tinychat (tinychat.com) or Twitcam (twitcam.com), a message is posted to the user's Twitter account “join me on tinychat . . . ”

### Automated/Robotic Activity

Retweeting that is mainly generated through Twitterfeed (www.twitterfeed.com) or similar services is classifies as automatic activity. Note that automated activity could be associated with any type of content, but since it has its own unique characteristics, different from all the aforementioned activities, it is included as a separate class. This can be identified by looking at the source of the tweet, which will identify twitterfeed (or a similar service) as the originator.

It was found that users respond to news stories and blog posts in identical manner, making them difficult to distinguish. Generally, the type of information contained in these two sources is also very similar. Therefore, for classification purposes, these may be put in the same category of newsworthy content.

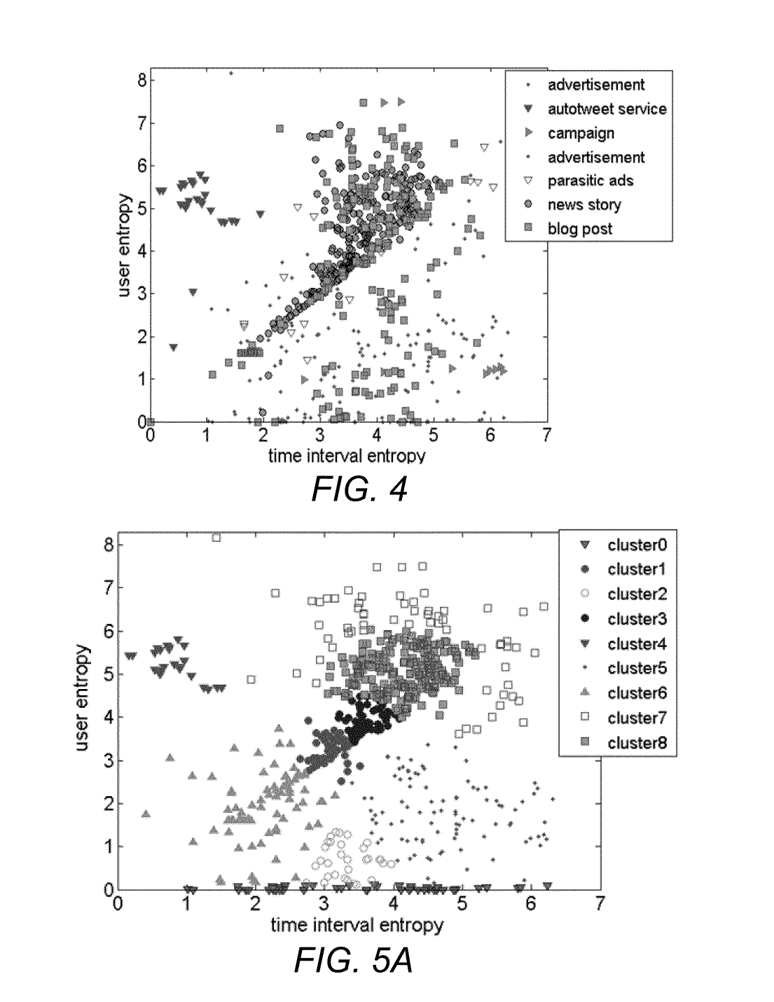

FIG. 4 illustrates an example of manually annotated URLs shown in an entropy plane. FIG. 4 shows the retweeting activity of URLs in the data sample as measured by the time interval and user entropy. The bulk of the URLs belong to news or blog category. They are also characterized by medium to high user entropy and time interval entropy, indicating newsworthy content. Blog posts or websites of major celebrities represent more popular content and are located in the upper section of the plot. Blog posts from starlets without major following are located in the lower section of the plot. Though these posts have similar numbers of retweets, lower user entropy means that the starlets, or their dedicated followers, generate much of the retweeting activity. The automatic retweeting cluster is isolated. This contains URLs like one whose activity is shown in FIG. 1E, but also several news stories, most notably from the online technology magazine TechCrunch. This is because many Twitter users employ Twitterfeed to automatically tweet stories that are posted on TechCrunch. This helps users appear to be more active on Twitter than they really are. The uninteresting stories are not retweeted by other people. They have low time interval entropy due to automatic retweeting, but high user entropy, since many different Twitter users are associated with the activity.

Advertisements are mostly located in the lower half of the figure, although successful advertisements that capture public interest are indistinguishable from newsworthy content. Unsuccessful campaigns that are driven by a few dedicated zealots are in their own cluster with high time interval and low user entropy, but successful campaigns are also indistinguishable from newsworthy content.

### Classification

The distribution of distinct time intervals and users involved in the retweeting activity gives a good characterization of the retweeting activity. As explained in Section 3, temporal and user entropy are used to quantify these distributions. Temporal entropy is maximum when the time intervals between any two successive retweets is different. User entropy is maximum when each user retweets the message only once. Next, using temporal and user entropies as features, the retweeting activity represented by a trace TⱼεT may be classified. Both unsupervised and supervised classification was performed. The data is manually labeled to train the supervised classifier and to evaluate the performance of the classification techniques. Weka software library (www.cs.waikato.ac.nz/ml/weak) was used for off-the-shelf implementation of EM (expectation maximization), A. Dempster, N. Laird, and D. Rubin, “Maximum likelihood from incomplete data via the EM algorithm”, Royal statistical Society B, 39:1, 38, 1977), k-NN (k-nearest neighbors) and SVM(support vector machines, B. E. Boser, I. M. Guyon, and V. N. Vapnik, “A training algorithm for optimal margin classifiers”, In Proceedings of the Fifth annual workshop on Computational learning theory, COLT '92, pages 144, 152, New York, N.Y., USA, 1992. ACM) classification.

### Supervised Classification

Support Vector Machine was used with radial basis function (RBF) kernel and k-NN algorithm with three nearest neighbors and Euclidean distance function to classify the data. Table 1 reports results of 10-fold cross validation in each model was trained on 90% of the labeled data and tested on the remaining 10%. The F-scores of both algorithms are relatively high, showing that they have well separated instances into different classes.

TABLE 1
F-Measure (F) and ROC area for 10-fold cross validation
experiments using SVM and k-NN classification

| | | ads & | auto- | | news & | parasitic |
|---|---|---|---|---|---|---|
| | | promotion | tweet | campaign | blog | ads |
| k-NN | F | 0.686 | 0.96 | 0.5 | 0.89 | 0.105 |
| | ROC | 0.807 | 0.959 | 0.678 | 0.837 | 0.644 |
| SVM | F | 0.719 | 0.939 | 0.526 | 0.897 | 0 |
| | ROC | 0.833 | 0.973 | 0.685 | 0.875 | 0.718 |

### Unsupervised Classification

Expectation Maximization (EM) algorithm was used to automatically cluster points. EM uses Gaussian mixture model and can decide how many clusters to create by cross validation. The number of clusters determined automatically by this method was nine.

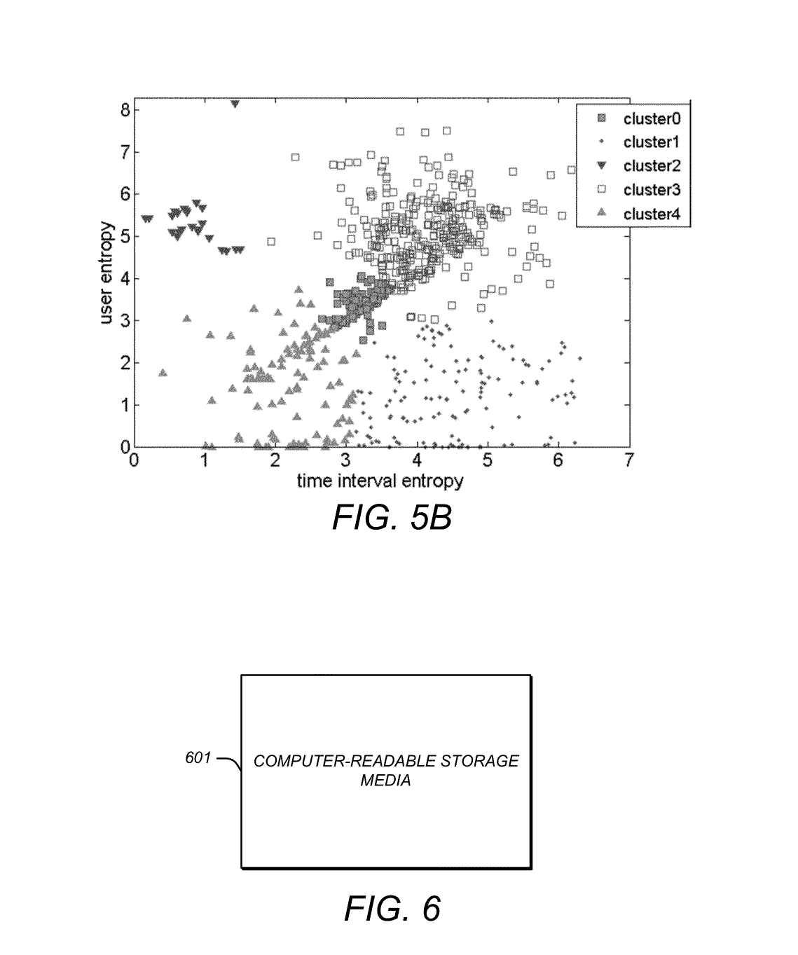

FIGS. 5A and 5B illustrate an example of unsupervised clustering of data points using an expectation maximizing (EM) algorithm. FIG. 5A shows the resulting clusters, and the confusion matrix is shown in Table 2. If the number of clusters were predefined to be 5, the resulting confusion matrix is shown in Table 3, and discovered clusters are shown in FIG. 5B.

TABLE 3
Confusion matrix with manually annotated data and clusters detected
by EM algorithm when number of clusters is predefined to be 5.

| | | | | news | |
|---|---|---|---|---|---|
| | advertisement | | | & | parasitic |
| | & promotion | auto-tweet | campaign | blogs | advertisements |
| cluster0 | 7 | 0 | 0 | 82 | 1 |
| cluster1 | 85 | 0 | 7 | 49 | 0 |
| cluster2 | 1 | 23 | 0 | 0 | 0 |
| cluster3 | 22 | 1 | 5 | 272 | 7 |
| cluster4 | 64 | 2 | 1 | 52 | 6 |

### Observations

Broadly speaking, five classes of retweeting activity and associated content on Twitter were identified.

### Automatic/Robotic Activity

As can be seen from the results, almost all methods classify automatic or robotic retweeting (auto-tweet) with high accuracy. Some of such activity in the data set is related to technology news stories. Their user entropy is similar to that of other news stories. However, such activity has a much lower time interval entropy than other news stories.

Two primary kind of automated services that were identified are auto-tweeting services and tweet-scheduling services. There are two categories of auto-tweeting activities.

The first arises when an individual subscribes to an automatic service that tweets messages on the user's profile on his behalf. One such automatic service is Twitterfeed (www.twitterfeed.com), through which the user can subscribe to a blog or news website (any service with an RSS feed). Twitter users employ this service to automatically retweet stories posted on technology news sites Mashable and TechCrunch. This leads to individual auto-tweets observed from the profile of that user.

However, this auto-tweeting feature is also being used for promotional and perhaps phishing activities. For example, a fan site (http://bieberinsanityblog.blogspot.com/) for Justin Bieber asks fans to provide their Twitter account information. The site is powered by Twitterfeed, and then auto-tweets Justin Bieber news from the profiles of registered fans, resulting in collective auto-tweeting.

Services like Tweet-u-later (http://www.tweet-u-later.com/) and Hootsuite can be used to schedule tweeting activities. These websites can be used for spamming. Registering a collection of profiles to these websites and scheduling the a tweet to posted repeatedly, enables spammers to post the same message multiple times.

Since the method described herein can differentiate human activity from bot or automated activity, marketing companies may be identified which engage automated services to increase their visibility on Twitter. Such services include OperationWeb (http://www.operationweb.com/) and TweetMaster (http://tweetmaster.tk/), which claim that they “will tweet your ad or message on my Twitter accounts that add up to over 170 thousand followers 2-6 times per day for 30 days.”

Most of these services use bots or automated services to push up the perceived visibility of the advertisements. To increase visibility they need a large number of profiles. To gain access to a large number of profiles, such services ask users to register, set their own prices for tweets and feature the sponsored tweets in their profile. In this way these services create a win-win situation, helping companies to promote their product and users to make money by featuring sponsored messages on their profiles.

### Newsworthy Information

This class comprises of mostly news and blogs and some successful campaigns. Newsworthy information is characterized by comparable (usually high) user and temporal entropy. Since people, not bots, are involved in disseminating such content, we call this “human response to information.” Both supervised and unsupervised clustering algorithms able to separate news and blogs, i.e., information sharing by humans, from the rest of retweeting activity with good accuracy (Tables 1, 3 and 2). However, EM algorithm with five classes breaks this class into smaller clusters (cluster0, cluster3 and cluster4). This is a meaningful subdivision based on popularity, with content in cluster3 being the most popular, content in cluster0 being normal content, and content in cluster4 having low popularity. When EM is allowed to automatically adjust the number of clusters, the popular clusters found by the earlier algorithm gets subdivided into two more classes giving five clusters of human response to information (cluster1, cluster3, cluster6, cluster7 and cluster8 in FIG. 5B). Compared to hand-labeled dataset (FIG. 4) and from the confusion matrix in Table 2, cluster7 comprises predominantly popular blogs, cluster8 comprises mostly popular news, cluster1 and cluster3 comprise normal human response to information, and cluster6 shows human response to unpopular information.

TABLE 2
Confusion matrix with manually annotated data and
clusters automatically detected by EM algorithm

| | | | | | | parasitic |
|---|---|---|---|---|---|---|
| | advertisement | auto- | | | | adver- |
| | & promotion | tweet | campaign | news | blogs | tisement |
| cluster0 | 45 | 0 | 0 | 0 | 8 | 0 |
| cluster1 | 7 | 0 | 0 | 41 | 13 | 1 |
| cluster2 | 17 | 0 | 0 | 0 | 14 | 0 |
| cluster3 | 0 | 0 | 0 | 53 | 10 | 1 |
| cluster4 | 0 | 23 | 0 | 0 | 0 | 0 |
| cluster5 | 53 | 0 | 7 | 2 | 34 | 0 |
| cluster6 | 36 | 2 | 1 | 27 | 19 | 6 |
| cluster7 | 10 | 1 | 3 | 14 | 30 | 6 |
| cluster8 | 11 | 0 | 2 | 130 | 60 | 0 |

### Advertisements and Promotions

Advertisements and promotions are distinguished by low user entropy and low to high temporal entropy. Supervised clustering is able to accurately detect advertisements and promotions (Table 1). Most spam-like advertisements fall in this section. These are unwanted advertisements which are never retweeted by any user besides the originator of the advertisement. EM algorithm with five classes also identifies a group comprising predominantly of advertisements. However, EM algorithm with automatic class detection, divides this group further into three classes: cluster0 comprising mostly of spam-like activity with very low user entropy (≈0), cluster2 containing advertisements with low user and medium time entropy, and cluster5 comprising of campaign-like promotions and advertisements with low user entropy and medium to high temporal entropy.

### Campaigns

Campaigns are identified by low user entropy and very high temporal entropy. There are very few campaigns in the hand-labeled dataset. Even then, supervised algorithms are able to classify campaigns with a fair degree of accuracy (cf. Table 1). However, unsupervised algorithm merges campaigns with advertisements and promotions. Due to considerable overlap of characteristics of campaigns with advertisements or promotions, to distinguish a campaign from an advertisement is difficult, even for manual annotators. Note, that when a campaign is very successful like the one by silva_marina, FIG. 1C, information that the campaigner intends to propagate spreads through the online social media. The retweeting activity in this case becomes similar to human response to information.

### Parasitic Advertisements

None of the methods were able to identify parasitic advertisements very accurately. One possible reason may be their parasitic nature, where they do not have a distinct characteristic feature of their own, but adopt the characteristics of the hosting user profile.

### Normalization

In order to make entropy values comparable, these values may be normalized. A variety of normalization procedures are available, depending on the application. Normalization may rescale values, so that they fall in the range of 0 and 1. When so normalized, values above 0.6 are considered to be high, above 0.8 to be very high, and below 0.4 to be low. The exact thresholds may be adjusted based on the specifics and needs of the application.

### CONCLUSION

The dynamics of retweeting activity associated with some content on Twitter can be characterized by the entropy of the user and time interval distributions. These two features alone are able to separate user activity into different meaningful classes. The method may be computationally efficient and scalable, content and language independent, and robust to missing data.

Entropy-based classification can be used for spam detection, trend identification, trust management, user modeling, understanding intent and detecting suspicious activity on online social media. Five categories of retweeting activity on Twitter have been identified: newsworthy information dissemination, advertisements and promotions, campaigns, automatic or robotic activity and parasitic advertisements. Human response to news, blogs, and celebrity posts may be very similar. The entropy-based classification method enables characterization of user activity and helps to understand user-generated content and separate popular content from normal or unpopular content.

This analysis may be applied to larger datasets and other online social media. There has been a gradual emergence of sophisticated spamming and birth of an alternate industry to manipulate content on Twitter like promotional activities to improve the perceived popularity of stars. H. Kwak, C. Lee, H. Park, and S. Moon, “What is Twitter, a social network or a news media?”, In Proceedings of the 19th international conference on World wide web, WWW '10, pages 591-600, New York, N.Y., USA, 2010, ACM, had asked an important question—What is Twitter, a Social Network or a News Media? An analysis of Twitter shows that it is not only both a social network but much more—the diversity of twitter activity is a reflection of complexity of collective user dynamics on online social media.

A computer system containing a program of instructions may be configured to make the various diversity determinations, including when using entropy, and the various content classifications that have now been discussed. The computer system includes one or more processors, tangible memories (e.g., random access memories (RAMs), read-only memories (ROMs), and/or programmable read only memories (PROMS)), tangible storage devices (e.g., hard disk drives, CD/DVD drives, and/or flash memories), system buses, video processing components, network communication components, input/output ports, and/or user interface devices (e.g., keyboards, pointing devices, displays, microphones, sound reproduction systems, and/or touch screens). The computer system may include one or more computers at the same or different locations. When at different locations, the computers may be configured to communicate with one another through a wired and/or wireless network communication system.

Each computer system may include software (e.g., one or more operating systems, device drivers, application programs, and/or communication programs). When software is included, the software includes programming instructions and may include associated data and libraries. When included, the programming instructions are configured to implement one or more algorithms that implement one or more of the functions of the computer system, as recited herein. The description of each function that is performed by each computer system also constitutes a description of the algorithm(s) that performs that function.

The software may be stored on or in one or more non-transitory, tangible storage devices, such as one or more hard disk drives, CDs, DVDs, and/or flash memories. The software may be in source code and/or object code format. Associated data may be stored in any type of volatile and/or non-volatile memory. The software may be loaded into a non-transitory memory and executed by one or more processors.

FIG. 6 illustrates an example of a computer-readable storage media 601. FIG. 19 illustrates an example of computer-readable storage media 1901. The media 601 may be non-transitory and tangible and may contain a program of instructions that constitute all or portions of the software that has been described herein.

The components, steps, features, objects, benefits, and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits, and advantages. These also include embodiments in which the components and/or steps are arranged and/or ordered differently.

For example, other measures could replace entropy in quantifying the amount of diversity, such as the Gini coefficient [http://en.wikipedia.org/wiki/Gini_coefficient], or the modified coefficient of variation [Allison, P. D. (1980). Inequality and scientific productivity. Social Studies of Science, 10(2):163-179.]

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases from a claim means that the claim is not intended to and should not be interpreted to be limited to these corresponding structures, materials, or acts, or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows, except where specific meanings have been set forth, and to encompass all structural and functional equivalents.

Relational terms such as “first” and “second” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element preceded by an “a” or an “an” does not, without further constraints, preclude the existence of additional elements of the identical type.

None of the claims are intended to embrace subject matter that fails to satisfy the requirement of Sections 101, 102, or 103 of the Patent Act, nor should they be interpreted in such a way. Any unintended coverage of such subject matter is hereby disclaimed. Except as just stated in this paragraph, nothing that has been stated or illustrated is intended or should be interpreted to cause a dedication of any component, step, feature, object, benefit, advantage, or equivalent to the public, regardless of whether it is or is not recited in the claims.

The abstract is provided to help the reader quickly ascertain the nature of the technical disclosure. It is submitted with the understanding that it will not be used to interpret or limit the scope or meaning of the claims. In addition, various features in the foregoing detailed description are grouped together in various embodiments to streamline the disclosure. This method of disclosure should not be interpreted as requiring claimed embodiments to require more features than are expressly recited in each claim. Rather, as the following claims reflect, inventive subject matter lies in less than all features of a single disclosed embodiment. Thus, the following claims are hereby incorporated into the detailed description, with each claim standing on its own as separately claimed subject matter.

The invention claimed is:

1. A non-transitory, tangible, computer-readable storage media containing a program of instructions configured to cause a computer system running the program of instructions to classify content of a message that is re-broadcasted in whole or in part by one or more re-broadcasters by:
determining an amount of time interval diversity in the time intervals between each successive pair of re-broadcasted messages;
determining an amount of re-broadcaster diversity in the number of times the message has been re-broadcasted by each of the re-broadcasters; and
classifying the content of the message based on the amount of time interval diversity and the amount of re-broadcaster diversity.

2. The storage media of claim 1 wherein the message is a tweet on Twitter™ and each rebroadcast is a retweet on Twitter™.

3. The storage media of claim 1 wherein the message includes a URL and each rebroadcast includes the URL.

4. The storage media of claim 1 wherein the amount of time interval diversity is computed using entropy.

5. The storage media of claim 1 wherein the amount of re-broadcaster diversity is computed using entropy.

6. The storage media of claim 5 wherein the amount of time interval diversity is computed using entropy.

7. The storage media of claim 1 wherein the classifying equates a low amount of time interval diversity with automatic or robotic activity.

8. The storage media of claim 7 wherein the amount of time interval diversity is computed using entropy.

9. The storage media of claim 1 wherein the classifying equates a high amount of re-broadcaster diversity and a high amount of time interval diversity with newsworthy information.

10. The storage media of claim 9 wherein the classifying equates a low amount of time interval diversity and a low amount of re-broadcaster diversity with spam.

11. The storage media of claim 9 wherein the amount of re-broadcaster and time interval diversity are computed using entropy.

12. The storage media of claim 1 wherein the classifying equates a low amount of re-broadcaster diversity with an advertisement or promotion.

13. The storage media of claim 12 wherein the amount of re-broadcaster diversity is computed using entropy.

14. The storage media of claim 1 wherein the classifying equates a low amount of re-broadcaster diversity and a high amount of time interval diversity with a campaign.

15. The storage media of claim 14 wherein the amount of re-broadcaster and time interval diversity are computed using entropy.

16. The storage media of claim 1 wherein the message contains text and the classifying classifies the text without analyzing the text.

17. The storage media of claim 1 wherein the message contains an image and the classifying classifies the image without analyzing the image.

18. The storage media of claim 1 wherein the message contains a video and the classifying classifies the video without analyzing the video.

19. The storage media of claim 1 wherein the classifying distinguishes between newsworthy content and spam based on the amount of time interval diversity and the amount of re-broadcaster diversity.

20. The storage media of claim 1 wherein the classifying is performed without analyzing the content.
